(19) United States
(12) Patent Application Publication
(10) Pub. No.: US 2012/0086598 A1
(43) Pub. Date: Apr. 12, 2012

(54) APPARATUS AND METHODS FOR DRIFTLESS ATTITUDE DETERMINATION AND RELIABLE LOCALIZATION OF VEHICLES

(75) Inventor: Farhad Aghili, Brossard (CA)

(73) Assignee: CANADIAN SPACE AGENCY, Saint-Hubert (CA)

(21) Appl. No.: 12/901,150

(22) Filed: Oct. 8, 2010

(51) Int. Cl. G01S 19/42; G01S 19/47

(52) U.S. Cl. 342/357.25; 342/357.3

(57) ABSTRACT

In order to determine positional information, about a mobile robot, Real Time Kinematic (RTK) Global Satellite Navigation System (GNSS) measurement data are obtained by at least two GNSS receivers mounted on the mobile robot. Estimates of the covariance matrices of the measurement data are computed. The RTK GNSS measurement data are combined according to the covariance matrices to obtain enhanced positional information. The results may be fused with data from an IMU to obtain driftless attitude and/or localization information.

### FIELD OF THE INVENTION

This invention relates to the field of robotics, and more particularly to the driftless attitude determination and reliable localization of vehicles, such as mobile robots, waking robots, or humanoid robots.

### BACKGROUND OF THE INVENTION

Both position and attitude determination of a mobile robot are necessary for navigation, guidance and steering control of the robot. Dead-reckoning using vehicle kinematic model and incremental measurement of wheel encoders are the common techniques to determine the position and orientation of mobile robots for indoor applications. However, the application of this technique for localization of outdoor robots is limited, particularly when the robot has to traverse an uneven terrain or loose soils. This is because wheel slippage and wheel imperfection cause quick accumulation of the position and attitude errors.

The problem with inertial systems is that they require additional information about absolute position and orientation to overcome long-term drift. An attitude estimation system based on utilization of multiple inertial measurements of a mobile robots is known. Only pitch and roll angles may be estimated in this method by using gravity components deduced from measurements of two accelerometer, but the yaw angle is not detectable. An integrated inertial platform consisting of three rate gyros, a triaxial accelerometer and two tilt sensors is known to minimize long-term drift. Other research focuses on using vision system as the absolute sensing mechanism required to update the prediction position obtained by inertial measurements.

Attitude determination GPS (ADGPS) using a multi-GPS antenna technology, in which the receiver gives not only the position but also the velocity data, are used for airborne applications as well as marine vessels and ships. Integration of such a GPS system and Inertial Navigation System (INS) is straightforward because attitude measurements from the two systems is directly available. ADGPS however need large antenna separation, e.g., 17 m, for offering competitive accuracy for azimuth and pitch determination of a ship. Multiple GPS antennas with separation distance of 11 m has been tried for attitude determination of aircraft. Methods for attitude estimation of UAVs based on position and velocity information obtained from a single GPS antenna have been disclosed. Since the velocity information is obtained from the Doppler shift measurement of the GPS carrier signals, these methods are suitable for fast moving vehicles such as UAVs, but not for mobile robots or humanoid robots.

Nowadays, differential Global Navigation Satellite Systems (GNSSs) to centimeter-level accuracy are commercially available making them attractive for localization, guidance and control of outdoor mobile robots. GNSS is the generic term for a satellite-based navigation system, such as the Global Positioning System (GPS), the Russian GLONASS, or European Galileo systems, and the term will be used in this specification to encompass all such systems. It will also be understood that in some environments, such as on mars, a satellite-based system may not be available. However, in such environments, it is possible to replace the satellites by transmitters placed at fixed locations that are functionally equivalent to satellites. Such transmitters are known as “pseudolites”, and it will be understood that the expression GNSS as used herein will also encompass such pseudolite-based systems. However, for convenience the invention will be described specifically in the context of the GPS system, which is the most widely used system today.

In conventional GPS, the pseudo ranges to satellites are measured by aligning the locally generated pseudorandom signal to the received signal. In Real Time Kinematic (RTK) GPS, and more specifically RTK GPS, an attempt is made to align the carriers rather than the signals modulated on to the carriers. Since the carriers are about 1000 times faster than the signals, considerable improvements in accuracy over conventional GPS can be achieved.

One method of improving the accuracy of localization systems using RTK GPS in the presence of GPS latency is to use a localization algorithm based on Kalman filtering that tries to fuse information coming from an inexpensive single GPS with inertial data and map-based data. A decentralized data fusion algorithm for simultaneous position estimation of a land vehicle and building the map of the environment by incorporating data from inertial sensor, GPS, laser scanner, the wheel and steering encoders is described in J. Vaganay, M. J. Aldon and A. Fournier, “Mobile robot attitude estimation by fusion of intertial data”, IEEE Int Conference on Robotics & Automation, Atlanta Georgia, May 1993, pp 277-282.

The use of vision systems has also been investigated. However, vision systems have proven to be sensitive to the lighting condition of the environment.

### SUMMARY OF THE INVENTION

According to a first aspect of the present invention there is provided a method of determining positional information about a vehicle, comprising: computing estimates of the covariance matrices of Real Time Kinematic (RTK) Global Satellite Navigation System (GNSS) measurement data obtained by at least two GNSS receivers mounted on the mobile vehicle; and fusing the RTK GNSS measurement data according to their corresponding covariance matrices to obtain enhanced positional information.

Embodiments of the invention provide a method for estimating vehicle attitude and position, in three dimensions, by optimally fusing two RTK GNSS measurements, accelerometric measurements of gravity from an accelerometer (or an inclinometer instrument) and angular rate measurements from a rate gyro. The relation between the GPS noises and the difference between the measured and actual antenna-to-antenna baselines is developed that allows to estimate the covariance matrix of the GNSS measurement noises.

First, the covariance matrices associated with the two RTK GNSS measurements are estimated based on the error on the magnitude of the antenna-to-antenna baseline measurement and the confidence of the GNSS receivers on the horizontal and vertical axes measurements. Then, the observation vector is constructed from the measurements of the onboard accelerometer and two RTK GNSSs. The measurement of the onboard rate gyro, the discrete-time observation as well as the estimated measurement covariance matrices are used by an Extended Kalman filter for driftless attitude determination of the mobile robot. Finally, the estimated attitude (in term of quaternion), RTK GPS measurements and the estimated covariance matrixes are used by another estimator to optimally localize the mobile robot by taking advantage of the redundancy in the GPS measurements plus the knowledge of the GNSS noise characteristics. This allows enhancing the accuracy and robustness of the GNSS-based localization of vehicles.

According to a second aspect of the invention there is provided an apparatus for determining positional information about a vehicle, comprising: at least two GNSS receivers for mounting on the vehicle robot and defining an antenna-to-antenna baseline therebetween; and a processor configured to compute estimates of the covariance matrices of Real Time Kinematic (RTK) Global Satellite Navigation System (GNSS) measurement data obtained by at least two GNSS receivers mounted on the vehicle, and to fuse the RTK GNSS measurement data according to their corresponding covariance matrices to obtain enhanced positional information.

A further aspect of the invention provides an apparatus for determining positional information about a vehicle, comprising at least two GNSS receivers for mounting on the vehicle and defining an antenna-to-antenna baseline therebetween; an inertial Measurement Unit (IMU) for obtaining data about the movement of the mobile robot; and a processor configured to and to fuse the RTK GNSS measurement data and the data from the IMU to obtain enhanced positional information.

### BRIEF DESCRIPTION OF THE DRAWINGS

The invention will now be described in more detail, by way of example only, with reference to the accompanying drawings, in which:

FIG. 1 is a block diagram of an apparatus in accordance with one embodiment of the invention;

FIG. 2 shows a mobile robot with two GPS antennas and an IMU mounted on the robot;

FIG. 3 shows a mobile robot with three GPS antennas and an IMU mounted on the robot for experimental purposes;

FIG. 4 shows the path taken by an experimental robot;

FIG. 5 shows the IMU outputs;

FIG. 6 shows the RTK GPS outputs;

FIG. 7 shows the confidence on the RTK GPS measurements;

FIG. 8 shows the estimated parameters;

FIG. 9 shows the vehicle attitude;

FIG. 10 shows the vehicle position;

FIG. 11 shows the attitude errors; and

FIG. 12 shows the position errors.

### DETAILED DESCRIPTION OF EMBODIMENTS OF THE INVENTION

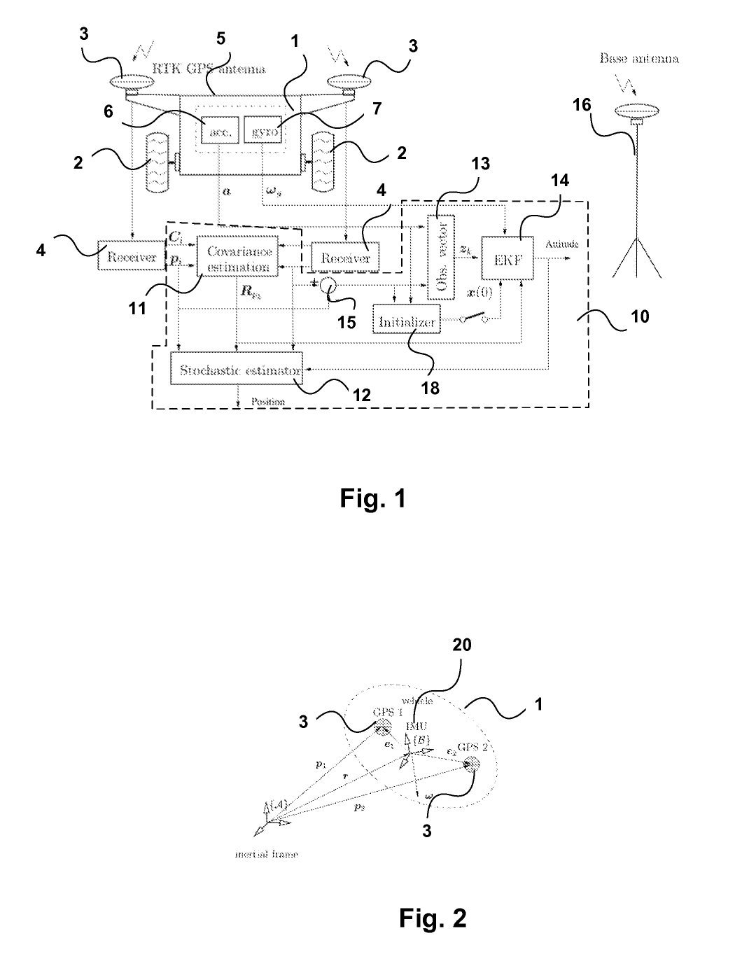

The apparatus shown in FIG. 1 comprises a vehicle 1 with wheels 2. A pair of RTK GPS antenna 3 coupled to respective GPS receivers 4, which may be differential receivers, are mounted a fixed distance apart on the vehicle 1 and separated by an antenna-to-antenna baseline 5. An accelerometer 6 and rate gyro 7 are mounted on the mobile robot 1. The embodiment will be described in connection with GPS, although as noted the invention applies more generally to any GNSS system, including systems using fixed pseudolites instead of satellites.

The mobile robot 1 also includes a processor 10, which may be a general-purpose computer, comprising a plurality of software/and or hardware modules, namely a covariance estimation module 11, a stochastic estimator module 12, an observation vector module 13, and an extended Kalman filter module 14, and an initializer 18.

The signals from the receivers 4 are subtracted from each other in subtraction module 15.

It will be understood that the various modules can be implemented in software, hardware or a combination of the two.

A base antenna 16 is also provided at a fixed location as is known in RTK GPS.

The method of estimating robot attitude and position, in three dimensions, involves optimally fusing two RTK GPS measurements, accelerometric measurements of gravity from an accelerometer (or an inclinometer) and angular rate measurements from a rate gyro in the Kalman filter 14 (KF). In addition to the pose, the KF 14 also estimates the gyro bias.

RTK GPS devices notoriously suffer from signal robustness issue as their signal can be easily disturbed by many factors such as satellite geometry, atmospheric condition and shadow. To deal with the uncertain GPS noise problem, the covariance matrix of the GPS noises is estimated in real-time so that the KF filter 14 is continually “tuned” as well as possible.

Kinematics

FIG. 2 schematically illustrates a vehicle 1 as a rigid body to which multiple differential GPS-antennas 3 and an IMU device are attached. Coordinate frame {A} is an inertial frame while {B} is a vehicle-fixed (body frame) coordinate system. The origin of frame {A} coincides with that of the base antenna of the differential GPS system, i.e., the GPS measurements are expressed in this frame. On the other hand, the origin of {B} coincides with the IMU center and their axes are parallel, i.e., the IMU measurements are expressed in {B} . The orientation of {B} with respect to {A} is represented by the unit quaternion q=[qᵥ^{T} g₀]^{T}, where subscripts v and o denote the vector and scalar parts of the quaternion, respectively. The rotation matrix A representing the rotation of frame {B} with respect to frame {A} is related to the corresponding quaternion q by

A(q)=(2qₒ²−1)1₃+2qₒ[qᵥ×]+2qᵥqᵥ^{T}, (1)

where [.×] denotes the matrix form of the cross-product. Consider quaternions q₁, q₂, and q₃. Then, A(q₃)=A(q₁)A(q₁) and q₃=q₂ [symbol] q₁ are equivalent, where [symbol] denotes the quaternion-product and the operators [q [symbol] ] is defined, analogous to the cross-product matrix as

$$[ q ⊗ ] = ϒ - diag ( [ {q}_{v} \times ] , 0 )$$

$$where ϒ = [ \begin{matrix}{q}_{0} & {q}_{v} \\ - {q}_{v}^{T} & {q}_{0}\end{matrix} ]$$

The conjugate q* of a quaternion is defined such that q* [symbol] q=q [symbol] q*=[0 0 0 1]^{T}.

Now, assume that vector r represents the location of the origin of frame {B} that is expressed in coordinate frame {A}, and pᵢ is the output of the ith GPS measurement. Apparently, from FIG. 2, we have

pᵢ=r+A(q)eᵢ+vₚ_{ᵢ} ∀i=1,2 (2)

where constant vectors eᵢs are the locations of the GPS antennas in the vehicle-fixed frame and vₚ_{ᵢ}s represent the GPS measurement noises, which are assumed random walk noises with covariance E[vₚ_{ᵢ}vₚ_{ᵢ}^{T}=Rₚ_{ᵢ}.

The IMU 20 is equipped with an accelerometer which can be used for accelerometric measurements of gravity. In general, accelerometer output contain components of the acceleration of gravity and the inertial acceleration. In mobile robots, the level of inertial acceleration is negligible compared to the acceleration of gravity; typically maximum inertial acceleration is about 0.02 g. Therefore, despite the fact that estimation of the inertial acceleration of the robot can be obtained from the GPS data, it is sufficient to model the inertial acceleration as a measurement noise in the KF. Let assume that a be the accelerometer output. Then, the acceleration equation can be written as

$$\frac{a}{‖ a ‖} = {A}^{T} k + {v}_{a} , \qquad ( 3 )$$

where ∥•∥ denotes the Euclidean norm, and unit vector k is defined to be aligned with the gravity vector in frame {A}, while vₐ captures the accelerometer noise and inertial acceleration all together. We treat vₐ as a random walk noise with covariance E[vₐvₐ^{T}]=σₐ²1₃.

Observation Equations

The objective of the extended Kalman filter (EKF) is to determine the vehicle attitude and position by fusing the IMU and GPS measurements.

In principle, the attitude of a rigid body can be determined from two non-collinear position vectors each of which expressed each in two coordinate systems. Equation (3) gives the gravity vector in both frames, while the baseline vector Δp≅p₁−p₂ is the rotated version of the vector from one antenna to the other, i.e., e₁−e₂. Therefore, equations (2) and (3) suffice to obtain the attitude q and the position r. However, this will lead to an inaccurate estimate because of low signal-to-noise ratio of the Δp measurement. Denoting vectors Δe=e₁−e₂ and vₚ=vₚ_{₂}−vₚ_{₁}, one can in from (2) that

$$‖ Δ e ‖ = ‖ Δ p + {v}_{p} ‖ \approx ‖ Δ p ‖ + Δ {\tilde{p}}^{T} {v}_{p} , \\ where \\ Δ \tilde{p} = \frac{Δ p}{‖ Δ p ‖} \qquad ( 5 )$$

and the RHS of (5) is obtained by the first-order approximation of the norm of summation of two vectors. Antenna-to-antenna baseline ∥Δe∥ is approximately 1 m, whereas the GPS error isabout ±5 cm. This means that the error in measurement of orientation of vector Δp is about 10%, which is far from desired accuracy. The two GPS observations in conjunction with the measurements of the acceleration gravity are used as external updates in an elaborate Kalman filter integrating a rate gyro data with the observation data.

In the described embodiment, the IMU signals are given at the rate of 20 Hz, whereas the GPS data can be acquired at the rate of 1 Hz. Therefore, an average of the IMU signal can be obtained between two consecutive GPS data acquisitions. This tends to decrease the IMU noise. Therefore, the discrete-time measurement of the acceleration can be obtained by averaging through integration of the IMU signals at that interval tₖ−t_{Δ}<t≦tₖ, where t_{Δ} denotes the GPS sampling rate, i.e.,

$${\overline{a}}_{k} = \frac{1}{{t}_{Δ}} {\int }_{{t}_{k - 1}}^{{t}_{k}} a ( ξ ) d ξ \qquad ( 5 )$$

Therefore, the discrete-time measurement vector is defined as

$${z}_{k} = [ \begin{matrix}{p}_{{1}_{k}} - {p}_{{2}_{k}} \\ {\overline{a}}_{k} / ‖ {\overline{a}}_{k} ‖\end{matrix} ] \qquad ( 6 )$$

In view of (2), (3) and (6), the observation vector as a function of the discrete-time variables qₖ and kₖ can be written as

$${h}_{k} = [ \begin{matrix}A ( {q}_{k} ) ( {e}_{1} - {e}_{2} ) \\ {A}^{T} ( {q}_{k} ) {k}_{k}\end{matrix} ] \qquad ( 7 )$$

Thus, the observation equation is

$${z}_{k} = {h}_{k} + {v}_{k} , \\ where {v}_{k} = [ \begin{matrix}{v}_{p {1}_{k}} - {v}_{p {2}_{k}} \\ {v}_{{a}_{k}}\end{matrix} ]$$

is the overall additive measurement noise. Assuming that the noises of the two GPS receivers are not mutually corrected and that they are also not corrected with the IMU noise, the covariance matrix of the measurement noise takes the form

$${R}_{k} = E [ {v}_{k} {v}_{k}^{T} ] = [ \begin{matrix}{R}_{{p}_{k}} & {0}_{3} \\ {0}_{3} & {σ}_{a}^{2} {1}_{3}\end{matrix} ] , \qquad ( 8 )$$

where

$${R}_{{p}_{k}} = {R}_{{p}_{{1}_{k}}} + {R}_{{p}_{{2}_{k}}} and {R}_{{p}_{{i}_{k}}} = E [ \begin{matrix}{v}_{{p}_{{i}_{k}}} & {v}_{{p}_{{i}_{k}}}^{T}\end{matrix} ]$$

is the covariance matrix associated with the measurement nose of the ith GPS.

The discrete-time observation vector (7) is a nonlinear function of the quaternion. To linearize the observation vector, one also needs to derive the sensitivity of the nonlinear observation vector with respect to the system variables. To this end, consider small orientation perturbations

δq=q [symbol] q̅*. (9)

around a nominal quaternion q̅. Now, by virtue of A(q)=A(δq [symbol] q̅), one can compute the observation vector (7) in terms of the perturbation δq. Using the first order approximation of nonlinear matrix function A^{T}(δq) from expression (1) by assuming a small rotation δq, i.e., ∥δqᵥ∥=1 and δq₀≈1, i.e.,

A(δq)≈1₃+2[δqᵥ×].

To take the decomposition rules of quaternion into account, the state vector to be estimated by the EKF is defined as

x=col(δqᵥ,b) (10)

where vector b is the corresponding gyro bias. Thus, the sensitivity matrix can be written as

$$H = ( \frac{\partial h}{\partial x} ) = [ \begin{matrix}- 2 \overline{A} [ ( {e}_{1} - {e}_{2} ) \times ] & {0}_{3} \\ 2 {\overline{A}}^{T} [ k \times ] \overline{A} & {0}_{3}\end{matrix} ] , \qquad ( 11 )$$

where Ā=A( q̅). Thus, the linearized observation equation is

zₖ≈Hxₖ±vₖ (12)

Covariance Estimation of the GPS Error

Efficient implementation of the KF requires the statistical characteristics of the measurement noise. The IMU noises are not usually characterized by time-invariant covariance. Therefore, σₐ is a constant parameter, which can be either derived from the sensor specification or empirically tuned. The GPS noise characteristics, however, are time-varying; the errors vary depending on many factors such as satellite geometry, atmospheric condition, multipath areas, and shadow.

The covariance of the GPS antenna-to-antenna measurements can be estimated from the difference between ∥Δp∥ and ∥Δe∥, which are both the antenna to antenna baselines expressed in two different frames. The magnitude of a vector is invariant under rotation transformation, i.e., ideally ∥Δp∥=∥Δe∥ if GPS data is noise-free. However, from the error equation (4), we can infer that

E[(∥Δpₖ∥−∥Δe∥)²]=Δ\tilde{p}ₖ^{T}Rₚ_{ₖ}Δ\tilde{p}ₖ. (13)

If the covariance matrix is assumed diagonal as

Rₚ_{ₖ}=σₚ_{ₖ}²1₃, (14)

then σₚ_{ₖ}²=E[(∥Δp∥−∥Δe∥)²]. Moreover, since GPS receivers estimate the position via the averaging process over the sampling interval, we can assume E[∥Δp∥]≈∥Δpₖ∥. Therefore, knowing that Δe is a deterministic variable, we can find the covariance from

σₚ_{ₖ}²=(∥Δpₖ∥−∥Δe∥)².

Most Real Time Kinematic (RTK) GPS receivers can estimate the confidence on their position measurements in real-time that allows us to characterize the covariance matrix more accurately. Typically, the positions of horizontal axes are measured with the same confidence, while the height measurements are given with less confidence. Therefore, for the i-th GPS, we can say Cᵢ=diag(cₕ_{ᵢ},cₕ_{ᵢ},cᵥ_{ᵢ}), where cₕ_{ᵢ} and cᵥ_{ᵢ} are the confidence on the horizontal and vertical measurement data that are provided by the receiver in real-time. We assume that

Rₚ_{ᵢ}=ρCᵢ² ∀i=1,2, (15)

where the scaling factor ρ is yet to be found. Substituting (15) in the RHS of (13) yields

$$ρ = \frac{{( ‖ Δ {p}_{k} ‖ - ‖ Δ e ‖ )}^{2}}{Δ {\tilde{ p}}_{k}^{T} ( {C}_{{1}_{k}}^{2} + {C}_{{2}_{k}}^{2} ) Δ {\tilde{p}}_{k}} .$$

Thus, the covariance matrix of the GPS noise can be computed from

$${R}_{{pi}_{k}} = \frac{{( ‖ Δ {p}_{k} ‖ - ‖ Δ e ‖ )}^{2}}{Δ {\tilde{ p}}_{k}^{T} ( {C}_{{1}_{k}}^{2} + {C}_{{2}_{k}}^{2} ) Δ {\tilde{p}}_{k}} {C}_{{i}_{k}}^{2} .$$

Attitude Estimation

The relation between the time derivative of the quaternion and the angular velocity ω can be readily expressed by

$$\dot{q} = \frac{1}{2} \underline{ω} ⊗ q \\ where \underline{ω} = [ \begin{matrix}ω \\ 0\end{matrix} ] . \qquad ( 16 )$$

The angular rate obtained from the gyro measurement is

ω_{g}=ω−b−ε_{g} (17)

where b is the corresponding bias vector; ε_{g} is the angular random walk noises with covariances E[ε_{g}ε_{g}^{T}]=σ_{g}²1₃. The gyro bias is traditionally modeled as

\dot{b}=ε_{b}, (18)

where ε_{b} is the random walk with covariances E[ε_{b}ε_{b}^{T}]=σ_{b}²1₃. Then, adopting a linearization technique one can linearize (16) about the nominal quaternion q̅ and nominal velocity

ω̅=ω_{g}+ b̅,

to obtain

$$\frac{d}{d t} δ {q}_{v} = - \overline{ω} \times δ {q}_{v} + \frac{1}{2} δ b + \frac{1}{2} {ɛ}_{g} . \qquad ( 19 )$$

Since δqₒ is not an independent variable and it has variations of only the second order, its time derivative can be ignored. Setting the dynamics equations (19) and (18) in the standard state space form, gives

$$\frac{d}{d t} x = Fx + G ɛ , \qquad ( 20 )$$

where ε=col(ε_{g},ε_{b}); and

$$F = [ \begin{matrix}- [ \overline{ω} \times ] & \frac{1}{2} {1}_{3} \\ {0}_{3} & {0}_{3}\end{matrix} ] , G [ \begin{matrix}\frac{1}{2} {1}_{3} & {0}_{3} \\ {0}_{3} & {1}_{3}\end{matrix} ]$$

Observabilty Analysis

A successful use of Kalman filtering requires that the system be observable. A linear time-invariant (LTI) systems is said to be globally observable if and only if its observability matrix is full rank. The observability matrix associated with linearized system (20) together with the observation model (11) is

O=[H^{T}(HF)^{T} . . . (HF⁵)^{T}]^{T}.

The states of the system are assumed to be completely observable if and only if rank 0 =6 (21)

which is equivalent to O having 18 independent rows.

Although the described system is not time-invariant as F and H are defined on the nominal trajectory at a frozen instant in time, examination of the LTI observability measure can still provide a useful insight into the local observability of the system at that time. To this end, we construct the submatrices of the observability matrix O, i.e.,

$$HF = [ - \overline{A} [ Δ e \times ] [ \overline{ω} \times ] \frac{1}{2} \overline{A} [ Δ e \times ] \overline{ω} \times ] \frac{1}{2} \overline{A} [ {k}^{′} \times ] ] \qquad ( 22 )$$

where k′=Ā^{T}k is the unit gravity vector expressed in the vehicle frame and we used the identity Ā^{T}[k×]Ā=[k′×] to obtain (22). The observability matrix can be reduced to the following block-triangular matrix by few elementary Matrix Row Operations (MRO)

$$\begin{matrix}O {\to }^{MRO} {O}^{′} = [ \begin{matrix}M & {0}_{3} \\ \times & M\end{matrix} ] , \\ where & ( 23 ) \\ M = [ {k}^{′} \times ] [ Δ e \times ] - [ Δ e \times ] [ {k}^{′} \times ] & ( 24 )\end{matrix}$$

and hence rank O=rank O′. It is clear from (23) that the full rankness of the block-triangular matrix rests on the invertibility of the square matrix M. In other words, if M is invertible, then the system is observable.

Proposition 1 If a line connecting the two GPS antennas is not collinear with the gravity vector, then system (12)-(20) is observable.

Proof: In a proof by contradiction, we show that M ∈ R^{3×3} must be a full-rank matrix. If M is not full-rank, then there must exist a non-zero vector η≠ 0_{3×1} such that

Mη=0_{3×1} (25)

In view of definition (24) and the property of the vector product of three vectors {a, b, c},

a×(b×c)=(a·c)b−(a·b)c,

one can easily show that LHS of (25) is equivalent to

$$\begin{matrix}M η = {k}^{′} \times ( Δ e \times η ) - Δ e \times ( {k}^{′} \times η ) \\ = ( {k}^{′} \cdot η ) Δ e - ( Δ e \cdot η ) {k}^{′} \neq 0 ,\end{matrix} \qquad ( 26 )$$

in which, the inequality of (26) is inferred from the fact that vectors k′ and Δe are not parallel and hence they can not annihilate one other. Therefore, it is not possible for (25) to be true meaning that matrix M must be full rank.

Discrete Time Model

The equivalent discrete-time model of (20) is

xₖ₊₁=Φₖxₖ+wₖ (27)

where Φₖ=Φ(tₖ+t_{Δ},tₖ) is the state transition matrix over time interval t_{Δ}. In order to find a closed form solution for the state transition matrix, we need the nominal values. The nominal values of the relevant states at interval tₖ<τ≦ₖ+t_{Δ} are obtained from the latest estimate update, i.e., q̅ₖ(τ)=\hat{q}ₖ, b̅ₖ(τ)=\hat{b}ₖ. Similar to (5), the nominal value of the angular velocity is obtained by averaging through integration of the IMU signals at that interval between two consecutive GPS data acquisition, i.e.,

$${\overline{ω}}_{k} = {\hat{b}}_{k} + \frac{1}{{t}_{Δ}} {\int }_{{t}_{k - 1}}^{{t}_{k}} {ω}_{g} ( ξ ) d ξ . \qquad ( 28 )$$

Therefore, the nominal angular velocity remains constant in the interval. Under these circumstances, the state transition matrix can be obtained in closed form for constant angular velocity or for varying angular velocity remains constant in direction. Let us define θₖ(τ)= ω̅ₖτ and θₖ=∥θₖ∥. Then, the state transition matrix Φₖ(τ)=Φ(τ,tₖ+τ) takes on the form:

$${Φ}_{k} ( τ ) = [ \begin{matrix}{Ψ}_{{1}_{k}} ( τ ) & \frac{1}{2} {Ψ}_{{2}_{k}} ( τ ) \\ 0 & {1}_{3}\end{matrix} ] \qquad ( 29 )$$

where the elements of the above matrix are given as

$${Ψ}_{{1}_{k}} ( {t}_{Δ} ) = {1}_{3} - \frac{sin {θ}_{k}}{{θ}_{k}} [ {θ}_{k} \times ] + {\frac{1 - cos {θ}_{k}}{{θ}_{k}} [ {θ}_{k} \times ]}^{2} \\ {Ψ}_{{2}_{k}} ( {t}_{Δ} ) = ( {1}_{3} + \frac{cos {θ}_{k} - 1}{{θ}_{k}^{2}} [ {θ}_{k} \times ] + {\frac{{θ}_{k} - sin {θ}_{k}}{{θ}_{k}^{3}} [ {θ}_{k} \times ]}^{2} ) {t}_{Δ} , \qquad ( 30 )$$

Let Σₑ=blockdiag(σ_{g}²1₃,σ_{b}²1₃) be the continuous-time covariance matrix of the entire process noise. Then, the corresponding discrete-time covariance matrix is

$${Q}_{k} = E [ {w}_{k} {w}_{k}^{T} ] = {\int }_{{t}_{k}}^{{t}_{k} + {t}_{{Δ}_{k}}} Φ ( t ) G {Σ}_{ɛ} {G}^{T} {Φ}^{T} ( t ) d t , \qquad ( 31 )$$

which has the following structure

$${Q}_{k} = [ \begin{matrix}{Λ}_{{1}_{k}} & {Λ}_{{2}_{k}} \\ \times & {σ}_{b}^{2} {t}_{Δ} {1}_{3}\end{matrix} ] \qquad ( 32 )$$

For small angle θₖ, where

$$sin {θ}_{k} \approx {θ}_{k} - \frac{1}{6} {θ}_{k}^{3} and cos {θ}_{k} \approx 1 - \frac{1}{2} {θ}_{k}^{2} ,$$

the elements of the state-transition matrix (30) can be effectively simplified. Then, upon integration of the substitution of the simplified state transition matrix into (31) we arrive at

$${Λ}_{{1}_{k}} = ( \frac{{σ}_{g}^{2} {t}_{Δ}}{4} + \frac{{σ}_{b}^{2} {t}_{Δ}^{3}}{12} ) {1}_{3} + {\frac{{σ}_{b}^{2} {t}_{Δ}^{3}}{240} [ {θ}_{k} \times ]}^{2} + {( \frac{{σ}_{g}^{2} {t}_{Δ}}{80} + \frac{{σ}_{b}^{2} {t}_{Δ}^{3}}{1008} ) [ {θ}_{k} \times ]}^{4}$$

$${Λ}_{{2}_{k}} = {σ}_{b}^{2} {t}_{Δ}^{2} ( \frac{1}{4} {1}_{3} - \frac{1}{12} [ {θ}_{k} \times ] + {\frac{1}{48} [ {θ}_{k} \times ]}^{2} ) .$$

Estimator Design

The state transition matrix (29) is used only for covariance propagation, while the system states have to be propagated separately by solving their own differential equations. Let us compose the redundant state ^{a}x=col(q,b), which contains the full quaternion q and parameters b. Combining (16), (18), we then describe the state-space model of the system as

^{a}\dot{x}=f(^{a}x,ε)

The EKF-based observer for the associated noisy discrete system (27) is given in two steps: (i) estimate correction

Kₖ=Pₖ⁻Hₖ^{T}(HₖPₖ⁻Hₖ^{T}±Rₖ)⁻¹ (33)

\hat{x}ₖ=\hat{x}ₖ⁻+K(zₖ−h(\hat{χ}ₖ⁻)) (34)

Pₖ=(1₁₂−KₖHₖ)Pₖ⁻ (35)

and (ii) estimate propagation

^{a}\hat{x}ₖ₊₁⁻=^{a}\hat{x}ₖ+∫ₜ_{ₖ}^{t}^{ₖ}^{+t}^{_{Δ}}f(^{a}x(t),0)dt (36)

Pₖ₊₁⁻=ΦₖPₖΦₖ^{T}+Qₖ (37)

The vector of discrete-time states, xₖ, which is to be estimated by the KF, contains only the variations δqᵥ_{ₖ} not the quaternion qₖ. However, the quaternion can be obtained from the former variables if the value of the nominal quaternion q̅ₖ is given, that is

δ\hat{q}ₖ⁻=\hat{q}ₖ⁻ [symbol] q̅*ₖ (38)

A natural choice for the nominal value of quaternion is its update estimate as q̅(tₖ₋₁)=\hat{q}ₖ₋₁. Since the nominal angular velocity ω̅ₖ is assumed constant at interval tₖ₋₁≦t≦tₖ, then, in view of (16), the nominal quaternion evolves from its initial value q̅(tₖ₋₁) to its final value q̅ₖ= q̅(tₖ) according to:

$${\overline{q}}_{k} = {e}^{\frac{1}{2} [ {\underline{θ}}_{k} ⊗ ]} {\hat{q}}_{k - 1} . \qquad ( 39 )$$

It can be shown that the above exponential matrix function has a closed-form expression so that the above equation can be written as

$${\overline{q}}_{k} = ( cos \frac{{θ}_{k}}{2} + sin \frac{{θ}_{k}}{2} ) {\hat{q}}_{k - 1} + ( \frac{2}{{θ}_{k}} sin \frac{{θ}_{k}}{2} - \frac{1}{2} cos \frac{{θ}_{k}}{2} ) {\underline{θ}}_{k} ⊗ {\hat{q}}_{k - 1} \qquad ( 40 )$$

From (38), the KF step, i.e., (34), can be written in terms of the full quaternion, qₖ instead of its variation δqᵥ_{ₖ}, as

$$[ \begin{matrix}δ {\hat{ q}}_{{v}_{k}} \\ {\hat{ρ}}_{k}\end{matrix} ] = [ \begin{matrix}vec ( {\hat{q}}_{\overline{k}} ⊗ {\overline{q}}_{k}^{*} ) \\ {\hat{ρ}}_{\overline{k}}\end{matrix} ] + K ( {z}_{k} - {h}_{k} ) \qquad ( 41 )$$

where q̅ₖ is obtained from (40). Finally, assuming that ∥δ\hat{q}ᵥ_{ₖ}∥<1, a valid unit quaternion can be constructed from

$${\hat{q}}_{k} = [ \begin{matrix}δ {\hat{q}}_{{v}_{k}} \\ \sqrt{1 - {‖ δ {\hat{q}}_{{v}_{k}} ‖}^{2}}\end{matrix} ] ⊗ \overline{q} ( {t}_{k} ) \qquad ( 42 )$$

Substituting (40) into (42) gives

$${\hat{q}}_{k} = [ \begin{matrix}δ {\hat{q}}_{{v}_{k}} \\ \sqrt{1 - {‖ δ {\hat{q}}_{{v}_{k}} ‖}^{2}}\end{matrix} ] ⊗ ( ( cos \frac{{θ}_{k}}{2} + sin \frac{{θ}_{k}}{2} ) {\hat{q}}_{k - 1} + ( \frac{2}{{θ}_{k}} sin \frac{{θ}_{k}}{2} - \frac{1}{2} cos \frac{{θ}_{k}}{2} ) {\underline{θ}}_{k} ⊗ {\hat{q}}_{k - 1} )$$

$$( Note the last θ in the above equation should be in bold )$$

Initialization of the Kalman Filter

For the first iteration of the EKF, an adequate guess of the initial states is required. The best guess for the parameters at t=0 s is =0₃, while the initial orientation of the vehicle with respect to the inertial frame at t=0 s is not known beforehand. It is that presumed ∥δqᵥ∥≦1. If this condition is violated, the error quaternion will not be unit norm. To prevent this from happening, it is important to keep the initial error in quaternion estimate small as much as possible.

Mathematically, the rotation matrix can be computed from two non-collinear unit vectors k and Δ\tilde{p} and their rotated versions ã≅a/∥a∥ and Δ\tilde{e}. Similar to the methods for registration of 3-D laser scanning data, let us form the following matrices from the units vectors as

Dₐ=[k Δ\tilde{p} k×Δ\tilde{p}] (43)

D_{b}=[ã Δ\tilde{e} ã×Δ\tilde{e}] (44)

Then, in the absence of measurement noise, i.e., v≡0, the above matrices are related by

Dₐ=AD_{b} (45)

Matrices Dₐ and D_{b} are non singular as long as k and Δ\tilde{j} are not collinear, i.e., the line connecting the GPS antennas is not parallel to the gravity vector. Then, under this circumstance, the rotation matrix can be obtained from

A=DₐD_{b}⁻¹ (46)

Solution (46) yields a valid rotation matrix A so that A^{T}A=1₃ , only if there is no error in the column vectors of matrices (45). However, due to the IMU and GPS noises, a valid rotation matrix may not be obtained from solution (46). To correct this problem, one may observe that all singular values of any orthogonal matrix must be one. This means that the singular value decomposition of the RHS of (33) yields

DₐD_{b}⁻¹=UΣV^{T},

where U and V are orthogonal matrices and matrix Σ=1₃+Δ_{Σ} is expected to be close to the identity matrix, i.e., ∥Δ_{Σ}∥ [symbol] 1. Therefore, by ignoring small matrix Δ_{Σ}, a valid solution to the rotation matrix can be found as

Â=UV^{T}, (47)

which then can be used to obtain the equivalent quaternion at t=0 s.

Position Estimation

With the estimation of attitude in hand, one can use the two sets of position and orientation equations (4) to compute r. Despite an estimate of r can be obtained from one set of equations, a better estimation can be achieved by solving two equations together if the measurement noise characteristic is known.

Setting the two GPS equations (4) in the matrix form, we get

$$y = Lr + \underbrace{{n}_{p} + {n}_{q}}_{noise} where y = [ \begin{matrix}{p}_{1} - \hat{A} {e}_{1} \\ {p}_{2} - \hat{A} {e}_{2}\end{matrix} ] , L = [ \begin{matrix}{1}_{3} \\ {1}_{3}\end{matrix} ] , \qquad ( 48 )$$

while GPS measurement errors and attitude estimation errors are respectively represented by vectors

$${n}_{p} = [ \begin{matrix}{v}_{{p}_{1}} \\ {v}_{{p}_{2}}\end{matrix} ] , {n}_{q} = - 2 \overline{A} [ \begin{matrix}[ {e}_{1} \times ] \\ [ {e}_{2} \times ]\end{matrix} ] δ {\tilde{q}}_{v} .$$

Using the argument that mutual correlation between nₚ and n_{q} is negligible, we can write the covariance matrix of the entire noise in (48) as:

$$\begin{matrix}{R}_{r} = E [ {n}_{p} {n}_{p}^{T} ] + E [ {n}_{q} {n}_{q}^{T} ] \\ = [ \begin{matrix}{R}_{{p}_{1}} + 4 \overline{A} [ {e}_{1} \times ] {P}_{q} [ {e}_{1} \times ] {\overline{A}}^{T} & 4 \overline{A} [ {e}_{1} \times ] {P}_{q} [ {e}_{2} \times ] {\overline{A}}^{T} \\ 4 \overline{A} [ {e}_{2} \times ] {P}_{q} [ {e}_{1} \times ] {\overline{A}}^{T} & {R}_{{p}_{2}} + 4 \overline{A} [ {e}_{2} \times ] {P}_{q} [ {e}_{2} \times ] {\overline{A}}^{T}\end{matrix} ]\end{matrix} \qquad ( 49 )$$

where P_{q}=E[δ\tilde{q}ᵥδ\tilde{q}ᵥ^{T}] ∈ R^{3×3}. Since the Kalman filer gives the covariance matrix of all estimated states including the quaternion, one can get P_{q} from the filter covariance matrix as

$$P = [ \begin{matrix}{P}_{q} & \times \\ \times & \times \end{matrix} ] ∈ {R}^{6 \times 6} .$$

Then an optimal solution to (48) can be obtained by the weighted pseudo inverse where a suitable weighting matrix is the covariance matrix of the noise. That is

$$\hat{r} = {( {L}^{T} {R}_{r}^{- 1} L )}^{- 1} {L}^{T} {R}_{r}^{- 1} y , [ \begin{matrix}{p}_{1} - \hat{A} {e}_{1} \\ {p}_{2} - \hat{A} {e}_{2}\end{matrix} ] \qquad ( 50 )$$

Using (48) in (50) yields

\hat{r}=(L^{T}Rᵣ⁻¹L)⁻¹L^{T}Rᵣ⁻¹

If the orientation estimation error is sufficiently small, i.e., the second term in RHS of (49) is negligible, then (50) can be conveniently written as

\hat{r}=W₁(p₁−Ae₁)+W₂(p₂−Ae₂),

where the weighting matrices are defined as

W₁≅Rₚ_{₂}(Rₚ_{₁}+Rₚ_{₂})⁻¹ (52)

W₂≅Rₚ_{₁}(Rₚ_{₁}+Rₚ_{₂})⁻¹. (53)

It is worth noting that W₁+W₂=1₃. This means that the estimator (51) proportionally puts more weight on that GPS measurement with the smallest covariance matrix in order to estimate the position.

Experimental Verification

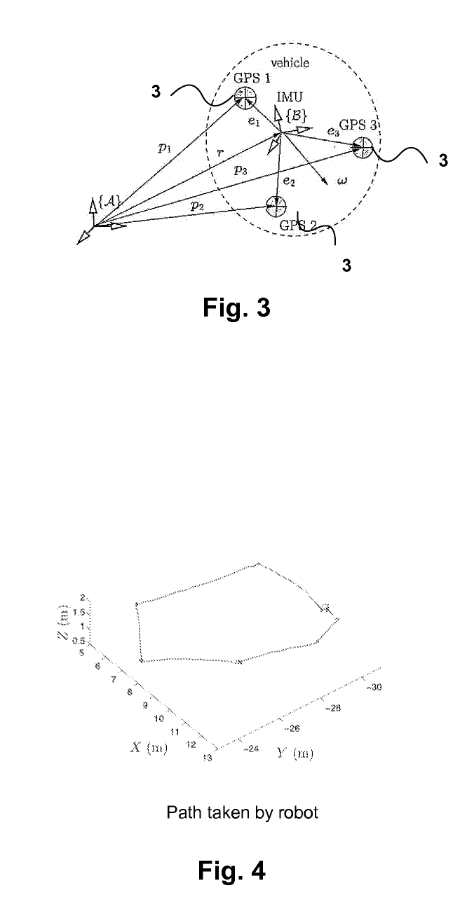

The test vehicle was equipped with three RTK GPS antennas as shown in FIG. 3. Although only two GPSs are required by the adaptive KF, having three GPSs allowed measurement of the vehicle attitude purely from a kinematic relation. Despite its poor accuracy, the three-GPS attitude determination method does not introduce any attitude drift. Therefore, it was possible to investigate whether or not the pose estimation method based on fusing two GPSs and an IMU exhibits any drift.

Assume that p₃ and e₃ denote the third GPS measurement and the location of its antenna on the vehicle, respectively. Also, denote Δp′=p₁−p₃ and Δe′=e₁−e₃ and

Nₐ=[Δp Δp′ Δp×Δp′]

N_{b}=[Δe Δe′ Δe×Δe′] (54)

where identity Nₐ=AN_{b} holds in the absence of GPS measurement noise. Therefore, in a development similar to (40) -(47), one can calculate the rotation matrix from the above matrices.

A rover equipped with three RTK GPS receivers along with satellite antennas and radio modems (model Promark3RTK from Magellan Navigation Inc.) in addition to an INIU device from Crossbow Technology, Inc. (model IMU300) was used for experiments. Experiments were conducted on the 30×60 m Mars Emulation Terrain (MET) of the Canadian Space Agency. The locations of the GPS antennas expressed in the vehicle-frame are shown in the following table. The additional GPS receiver was provided to permit estimation of the vehicle pose indpendently of the IMU measurements.

TABLE

| | x(m) | y(m) | z(m) |
|---|---|---|---|
| e₁ | −0.452 | 0.604 | −0.252 |
| e₂ | −0.452 | −0.616 | −0.224 |
| e₃ | −0.427 | −0.003 | −0.249 |

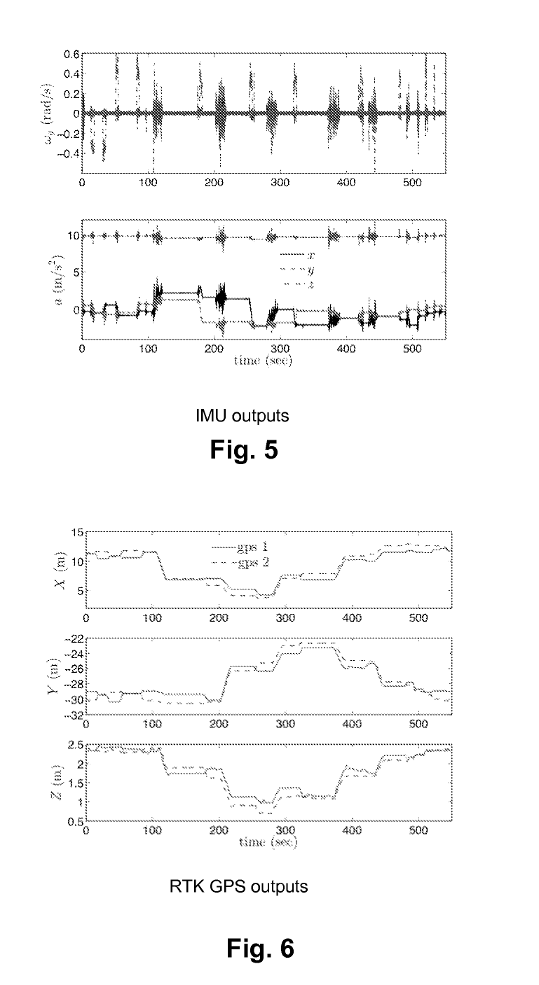

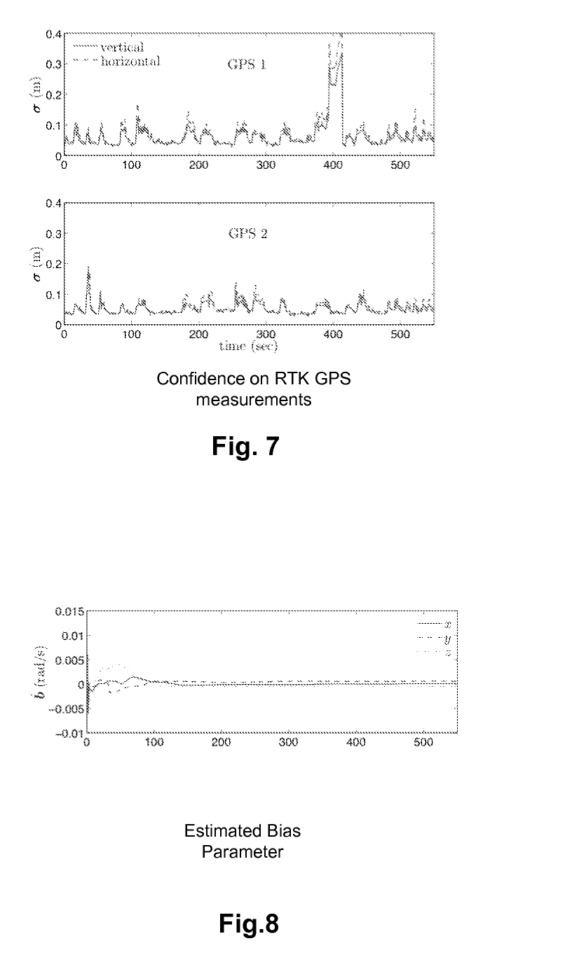

An operator sent a pre-scheduled sequence of primitive commands to the mobile robot-e.g., “move forward of a certain distance”, “rotate clockwise by 45°”, etc-so that the robot follows a preplanned path going through some specified via points. FIG. 4 shows the 3-D path taken by the mobile robot. The time-histories of the IMU measurements and GPS measurements are depicted in FIGS. 5 and 6, respectively, while the time-history of the confidence on the GPS data is shown in FIG. 7.

The Two-GPS-IMU fusion method was compared with One-GPS-IMU method. Although it was not possible to obtain ground truth attitude and position information during the test, it was possible to obtain an estimate of the attitude without any drift and a fairly reliable estimate of position by processing the data acquired from the three GPS receivers.

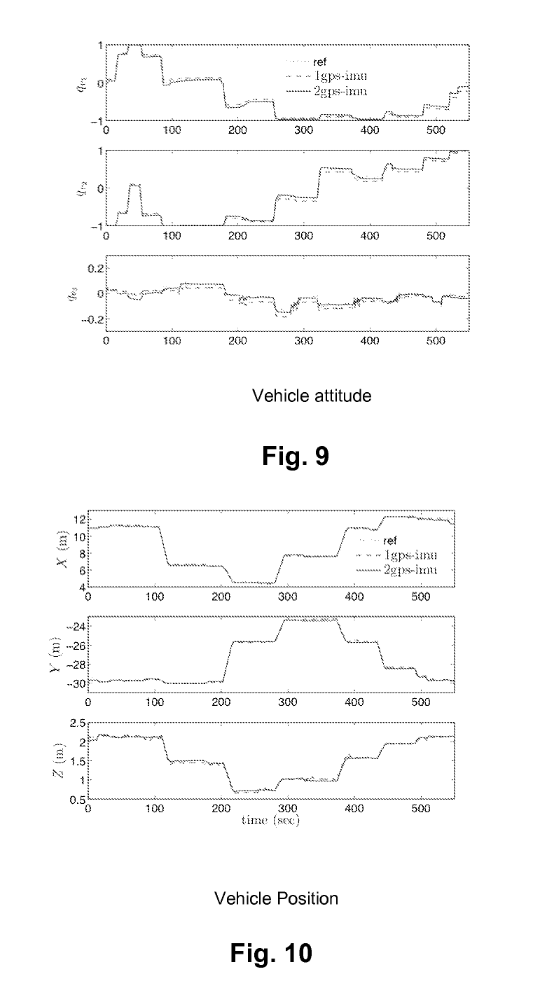

FIG. 8 shows that the Kalman Filter can quickly identify the parameters, i.e., gyroscope bias and the direction cosines of the gravity vector in the inertial frame. Trajectories of the vehicle position and attitude based on the Two-GPS-IMU fusion method and One-GPS-IMU method versus the results of the geometric pose estimation process based on the data of the three GPS receivers (used as the reference) are plotted in FIGS. 9 and 10, respectively. The errors between the estimated and the reference pose trajectories are calculated by

Position Error=∥\hat{r}−r_{ref}∥

Orientation Error=2 sin⁻¹∥vec(q_{ref} [symbol] \hat{q}*)∥

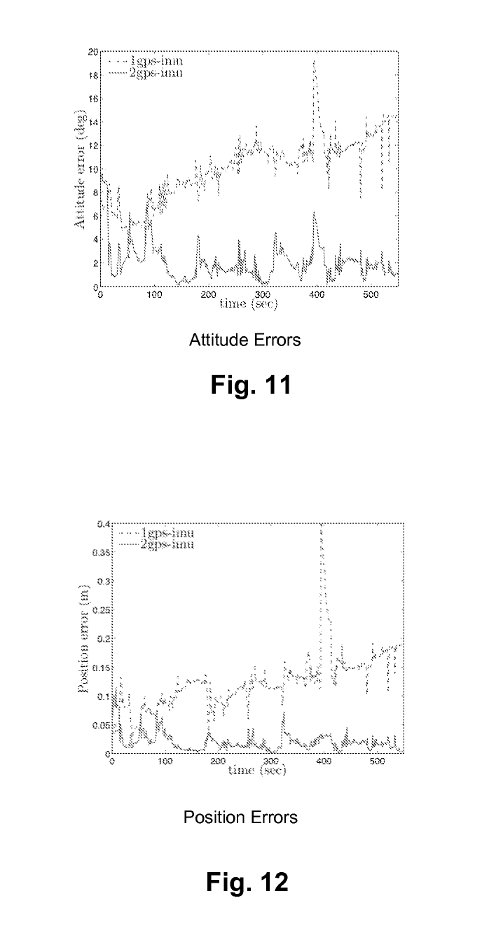

and the results are plotted in FIGS. 11 and 12. It is clearly evident from FIG. 11 that the attitude estimation error using one GPS and IMU accumulates gradually due to gyro drift, whereas the Two GPS-IMU method exhibits no drift. As shown in FIG. 12, the position estimation based on one GPS also exhibits drift, which is the echoed attitude drift. Furthermore, it is apparent from the figure that the position estimation based on one GPS measurement is not accurate at the time around t=400 s, because the error margin of the first GPS receivers during that period is incidentally high, as shown FIG. 6. Both drift and spike in the position errors are substantially reduced in the Two-GPS-IMU estimation method.

The described system can be used for outdoor mobile robots for terrestial applications and to provide a ground-truth pose estimation of a vehicle during testing. The system is also applicable to applications on other worlds, such as the Moon or Mars, where low power pseudolites can be substituted for orbiting satellites.

1. A method of determining positional information about a vehicle, comprising:
computing estimates of the covariance matrices of Real Time Kinematic (RTK) Global Satellite Navigation System (GNSS) measurement data obtained by at least two GNSS receivers mounted on the vehicle; and
fusing the RTK GNSS measurement data according to their corresponding covariance matrices to obtain enhanced positional information.

2. The method of claim 1, wherein an antenna-to-antenna baseline is defined between the GNSS receivers, and the estimates of the covariance matrices are based on the error in the magnitude of a measurement of the antenna-to-antenna baseline and the confidence in the GNSS receiver measurements.

3. The method of claim2, wherein the antenna-to-antenna baseline is not collinear with the vector of gravity.

4. The method of claim 2, wherein the measurement data from the RTK GNSS receivers is fused with measurement data from an inertial measurement unit (IMU).

5. The method of claim 4, wherein the IMU includes an onboard accelerometer and rate gyro.

6. The method of claim 4, wherein the IMU includes an onboard inclinometer and rate gyro.

7. The method of claim 4, wherein the measurement data is fused in a Kalman filter.

8. The method of claim 7, wherein the positional information comprises attitude information obtained from the Kalman filter.

9. The method of claim 8, wherein the attitude information is derived from the quaternion
$${\hat{q}}_{k} = [ \begin{matrix}δ {\hat{q}}_{{v}_{k}} \\ \sqrt{1 - {‖ δ {\hat{q}}_{{v}_{k}} ‖}^{2}}\end{matrix} ] ⊗ ( ( cos \frac{{θ}_{k}}{2} + sin \frac{{θ}_{k}}{2} ) {\hat{q}}_{k - 1} + ( \frac{2}{{θ}_{k}} sin \frac{{θ}_{k}}{2} - \frac{1}{2} cos \frac{{θ}_{k}}{2} ) {\underline{θ}}_{k} ⊗ {\hat{q}}_{k - 1} )$$
$$( Note the last θ in the above equation should be in bold )$$

10. The method of claim 7, wherein the positional information also comprises localization information.

11. The method of claim 10, wherein the localization information is derived from the equation
$$\hat{r} = {( {L}^{T} {R}_{r}^{- 1} L )}^{- 1} {L}^{T} {R}_{r}^{- 1} [ \begin{matrix}{p}_{1} - \hat{A} {e}_{1} \\ {p}_{2} - \hat{A} {e}_{2}\end{matrix} ]$$
where the weighting matrix is defined as
$${R}_{r} = [ \begin{matrix}{R}_{{p}_{1}} + 4 \overline{A} [ {e}_{1} \times ] {P}_{q} [ {e}_{1} \times ] {\overline{A}}^{T} & 4 \overline{A} [ {e}_{1} \times ] {P}_{q} [ {e}_{2} \times ] {\overline{A}}^{T} \\ 4 \overline{A} [ {e}_{2} \times ] {P}_{q} [ {e}_{1} \times ] {\overline{A}}^{T} & {R}_{{p}_{2}} + 4 \overline{A} [ {e}_{2} \times ] {P}_{q} [ {e}_{2} \times ] {\overline{A}}^{T}\end{matrix} ]$$

12. The method of claim 4, wherein the covariance matrix of the GNSS measurement noise is derived from equation
$${R}_{{pi}_{k}} = \frac{{( ‖ Δ {p}_{k} ‖ - ‖ Δ e ‖ )}^{2}}{Δ {\tilde{p}}_{k}^{T} ( {C}_{{1}_{k}}^{2} + {C}_{{2}_{k}}^{2} ) Δ {\tilde{p}}_{k}} {C}_{{i}_{k}}^{2} .$$

13. The method of claim 7, wherein the initial states of the Kalman filter are determined from difference between the two GNSS measurements and the accelerometer measurement.

14. The method of claim 4, further comprising computing an observation vector from measurements obtained from the accelerometer and the GNSS receivers, and applying the observation vector, the estimates of the covariance matrices and measurements obtained from the onboard rate gyro as inputs to a Kalman filter to determine the attitude of the vehicle.

15. The method of claim 1, wherein at least three GNSS receivers are mounted on the vehicle and a pose estimation is obtained from measurements from the three GNSS receivers.

16. The method of claim 1, wherein the GNSS receivers compute their ranges with respect to a stationary GNSS base station.

17. An apparatus for determining positional information about a vehicle, comprising:
at least two GNSS receivers for mounting on the vehicle and defining an antenna-to-antenna baseline therebetween; and
a processor configured to compute estimates of the covariance matrices of Real Time Kinematic (RTK) Global Satellite Navigation System (GNSS) measurement data obtained by at least two GNSS receivers mounted on the mobile robot, and to fuse the RTK GNSS measurement data according to their corresponding covariance matrices to obtain enhanced positional information.

18. The apparatus of claim 17, wherein an antenna-to-antenna baseline is defined between the GNSS receivers, and the estimates of the covariance matrices are based on the error in the magnitude of a measurement of the antenna-to-antenna baseline and the confidence in the GNSS receiver measurements.

19. The apparatus of claim 18, wherein an antenna-to-antenna baseline is not collinear with the vector of gravity.

20. The apparatus of claim 17, wherein the processor is configured to fuse measurement data from the RTK GNSS receivers with measurement data from an inertial measurement unit (IMU).

21. The apparatus of claim 20, wherein the IMU includes an onboard accelerometer and rate gyro.

22. The apparatus of claim 20, wherein the IMU includes an onboard inclinometer and rate gyro

23. The apparatus of claim 20, wherein the processor comprises a Kalman filter.

24. The apparatus of claim 23, wherein the Kalman filter is configured to produce attitude information about the vehicle.

25. The apparatus of claim 24, wherein the attitude information is derived from the equation
$${\hat{q}}_{k} = [ \begin{matrix}δ {\hat{q}}_{{v}_{k}} \\ \sqrt{1 - {‖ δ {\hat{q}}_{{v}_{k}} ‖}^{2}}\end{matrix} ] ⊗ ( ( cos \frac{{θ}_{k}}{2} + sin \frac{{θ}_{k}}{2} ) {\hat{q}}_{k - 1} + ( \frac{2}{{θ}_{k}} sin \frac{{θ}_{k}}{2} - \frac{1}{2} cos \frac{{θ}_{k}}{2} ) {\underline{θ}}_{k} ⊗ {\hat{q}}_{k - 1} )$$

26. The apparatus of claim 24, wherein the positional information also comprises localization information.

27. The apparatus of claim 26, wherein localization information is derived from the equation
$$\hat{r} = {( {L}^{T} {R}_{r}^{- 1} L )}^{- 1} {L}^{T} {R}_{r}^{- 1} [ \begin{matrix}{p}_{1} - \hat{A} {e}_{1} \\ {p}_{2} - \hat{A} {e}_{2}\end{matrix} ]$$
where the weighting matrix is defined as
$${R}_{r} = [ \begin{matrix}{R}_{{p}_{1}} + 4 \overline{A} [ {e}_{1} \times ] {P}_{q} [ {e}_{1} \times ] {\overline{A}}^{T} & 4 \overline{A} [ {e}_{1} \times ] {P}_{q} [ {e}_{2} \times ] {\overline{A}}^{T} \\ 4 \overline{A} [ {e}_{2} \times ] {P}_{q} [ {e}_{1} \times ] {\overline{A}}^{T} & {R}_{{p}_{2}} + 4 \overline{A} [ {e}_{2} \times ] {P}_{q} [ {e}_{2} \times ] {\overline{A}}^{T}\end{matrix} ]$$

28. The apparatus of claim 23, wherein the initial states of the Kalman filter is determined from the difference between GPS measurements and the accelerometer measurement.

29. The apparatus of claim 21, comprising a module for computing an observation vector from measurements obtained from the accelerometer and the GPS receivers, and a Kalman filter receiving as inputs the observation vector, the estimates of the covariance matrices and measurements obtained from the onboard rate gyro and outputting the attitude of the mobile robot.

30. The apparatus of claim 17, comprising at least three GNSS receivers mounted on the mobile robot, and wherein the processor is configured to obtain a pose estimation from measurements from the two GPS receivers.

31. The apparatus of claim 17, wherein the GNSS receivers are configured to compute their ranges with respect to a stationary GNSS base station.

32. An apparatus for determining positional information about a vehicle, comprising:
at least two GNSS receivers for mounting on the vehicle and defining an antenna-to-antenna baseline therebetween;
an inertial Measurement Unit (IMU) for obtaining data about the movement of the mobile robot; and
a processor configured to and to fuse the RTK GNSS measurement data and the data from the IMU to obtain enhanced positional information.

33. The apparatus of claim 32, wherein the processor is configured to compute estimates of the covariance matrices of Real Time Kinematic (RTK) Global Satellite Navigation System (GNSS) measurement data obtained by at least two GNSS receivers mounted on the vehicle and to fuse the RTK GNSS measurement data according to their corresponding covariance matrices.

34. The apparatus of claim 32, wherein the vehicle is a mobile robot or a walking robot or a humanoid robot.
